(19) United States
(12) Patent Application Publication
(10) Pub. No.: US 2006/0231285 A1
(43) Pub. Date: Oct. 19, 2006

(54) System for electrically connecting and fixing at least one conductor to a support piece

(76) Inventors: Didier Bisson, Doubs (FR); Gabriel Camacho, Guenange (FR); Hervé Krattinger, Pontarlier (FR); Régis Marmier, Frasne (FR)

Correspondence Address: HARRINGTON & SMITH, LLP, 4 RESEARCH DRIVE, SHELTON, CT, 06484-6212, US

(21) Appl. No.: 10/548,975

(22) PCT Filed: Mar. 1, 2004
(86) PCT No.: PCT/FR04/00473

§ 371 Date: Jun. 9, 2006

(30) Foreign Application Priority Data
Mar. 13, 2003 (FR) 0303131

(51) Int. Cl. H01R 4/18

(52) U.S. Cl. 174/94 R

(57) ABSTRACT

This system in which support piece is provided with a threaded pin designed to be engaged in a hole of conductor and to cooperate with a nut for screwing the conductor onto this piece, is characterized in that an annular spacer of electrically conductive material is joined to conductor on the side of this conductor that is facing the support piece, in that a ring is positioned on the opposite side of this conductor and includes floating means for coupling onto spacer designed to extend through hole of the conductor and in that nut is joined to the ring by coupling means allowing the rotation of nut relative to the ring and a determined course of axial movement for this nut relative to this ring, between a position of assembling distant from the ring and a position for screwing in which the nut is supported against the ring in order to facilitate the positioning, and then the screwing of conductor against support piece.

The present invention concerns a system for electrically connecting and fastening at least one plate-type electrical conductor onto a support piece.

More particularly, the invention relates to such systems in which the support piece is provided with a threaded pin designed to be engaged in a corresponding hole of the conductor and to cooperate with a nut for screwing the conductor onto the support piece.

Such connection systems are currently used, for example, in plate or busbar systems to assure the connection of electrical conductors.

One example of such a system is described in document FR-A-2,784,241.

It is also known that generally, these connection systems have a certain number of disadvantages, notably during positioning and screwing of the conductor against the support piece, in places that are difficult to access.

In fact, these connection systems are generally positioned in the bottom of electrical supply cabinets or baskets and are difficult to access by assemblers.

It can also happen that this assembler lets go off one or the other of the parts that make up these systems, and that this part is difficult or even impossible to recover.

Thus it can be seen that this is annoying, even dangerous, notably for the electrical integrity of the rest of the cabinet or basket.

The object of the invention is therefore to resolve these problems.

For this purpose, the subject of the invention is a system for electrically connecting and fastening at least one plate-type electrical conductor onto a support piece provided with a threaded pin designed to be engaged in a corresponding hole of the conductor and to cooperate with a nut for screwing the conductor onto the support piece, characterized in that an annular spacer of electrically conductive material is joined to the conductor, on the side of this conductor that faces the support piece, and in that a ring is positioned on the opposite side of this conductor and comprises floating means for coupling onto the spacer designed to extend through the corresponding hole of this conductor and in that the nut is joined to the ring by coupling means allowing the rotation of the nut relative to the ring and a determined course of axial movement of the nut relative to this ring, between a position of assembling distant from this ring and a position for screwing in which the nut is supported against this ring, in order to facilitate the positioning and then the screwing of the conductor against the support piece.

According to other characteristics:

the hole of the conductor has a generally oblong shape in order to facilitate centering it on the threaded pin;

the means for coupling the ring onto the spacer comprise hook-type tabs designed to engage in the corresponding hole of the conductor and to cooperate with the complementary stop means of this spacer;

the means for coupling the nut onto the ring comprise hook-type tabs designed to cooperate with the complementary stop means of this ring;

the means for coupling the nut onto the ring have the form of a tubular sleeve of the nut provided with stop means designed to cooperate with the complementary stop means of the ring;

the complementary stop means comprise at least one corresponding rim;

the support piece has a reinforcement piece at the level of the threaded pin;

the support piece is formed by another conductor;

the support piece is formed by an electrical component; and

the support piece is formed by an electrical connection plate.

The invention will be better understood upon reading the description that follows, given solely by way of example and made in reference to the attached drawings, in which:

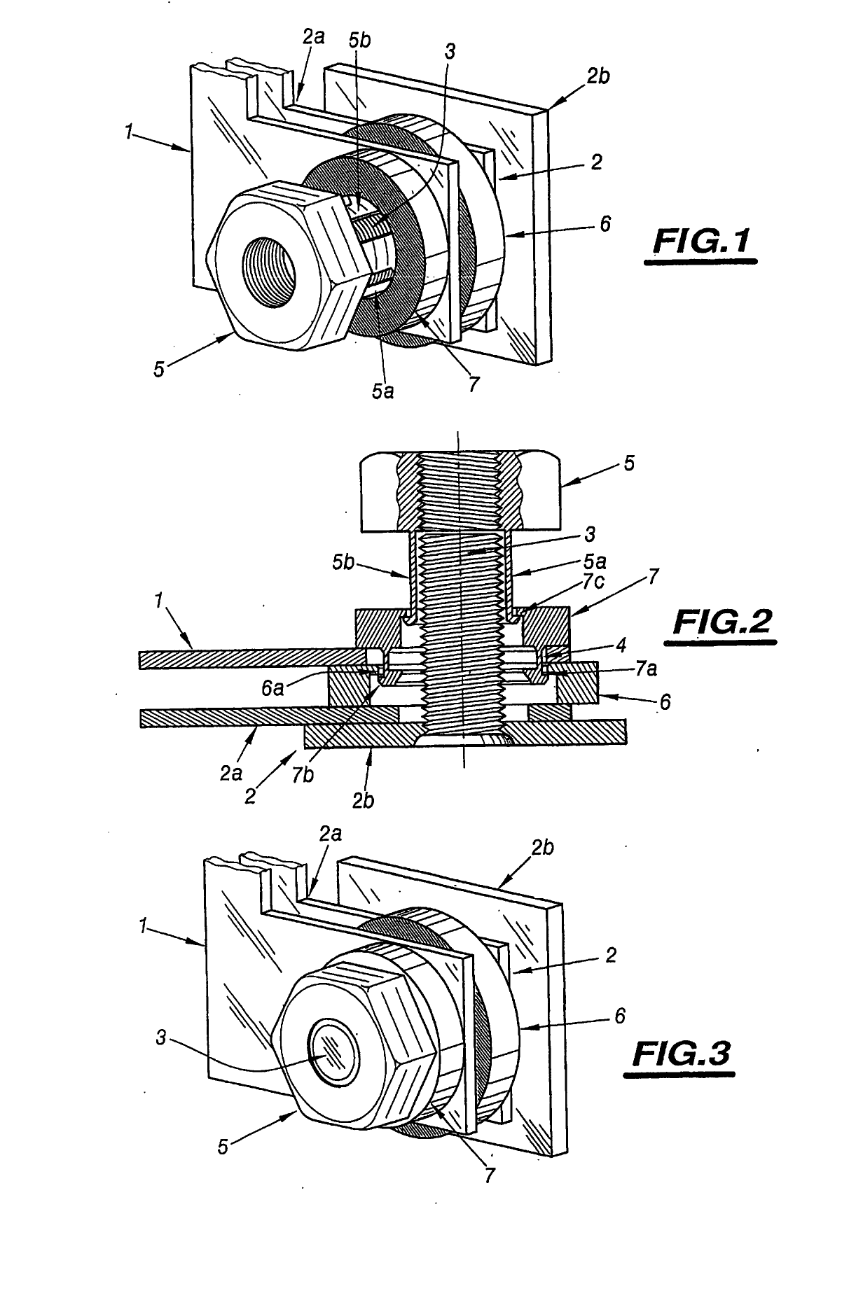

FIG. 1 shows a perspective view of an electrical connection system according to the invention in the position of assembling;

FIG. 2 shows a sectional view of such a system;

FIG. 3 shows a perspective view of such a system in the position of screwing;

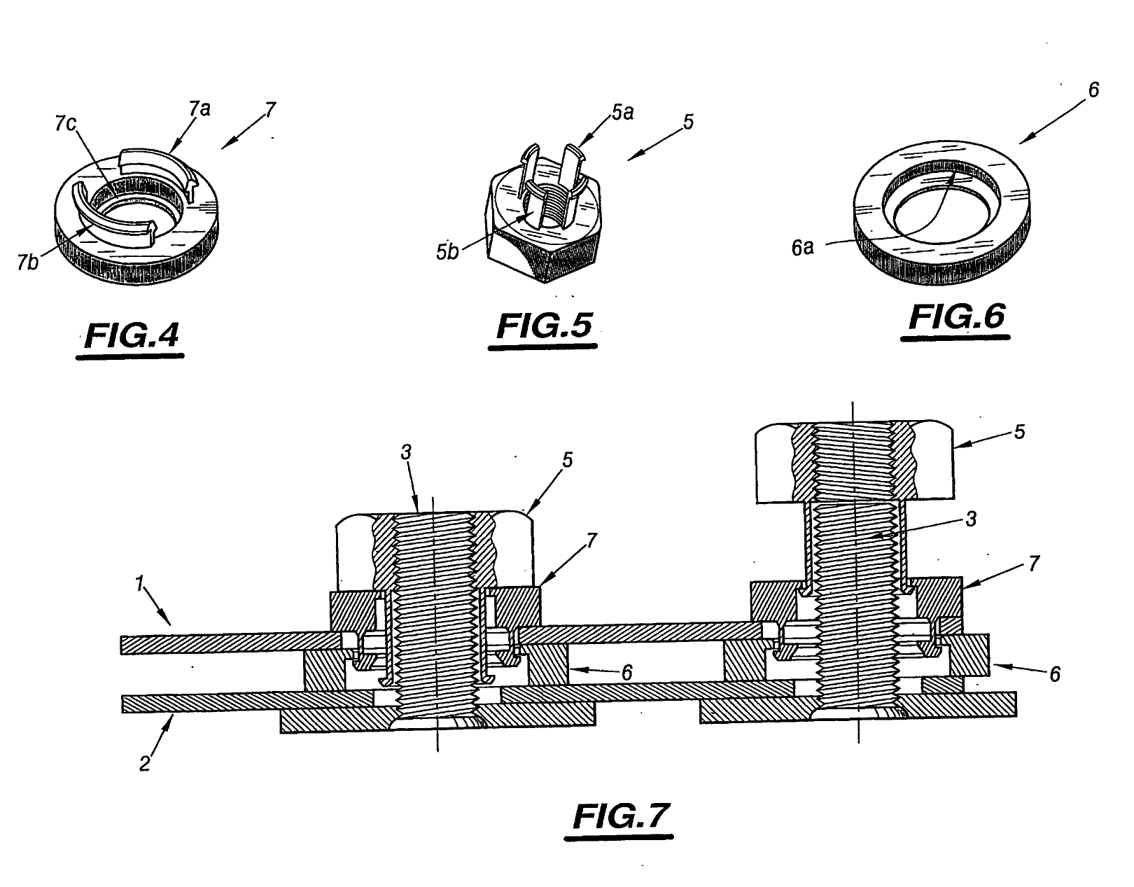

FIGS. 4, 5 and 6 represent perspective views, respectively, of a ring, a nut, and an annular spacer included in the constitution of such a system; and

FIG. 7 shows a sectional view of one example of application of such a connection system.

In fact, a system for electrically connecting and fastening at least one plate-type electrical conductor, designated by general reference 1, onto a support piece, designated by general reference 2, is shown in FIGS. 1 to 6.

This support piece 2 has a threaded pin designated by general reference 3, designed to be engaged in a corresponding hole 4 of conductor 1 and to cooperate with a nut 5 for screwing the conductor onto support piece 2.

In fact, different variants of embodiment of the support piece can be envisioned.

Thus, this support piece 2 can be formed by another conductor, an electrical component, a plate or bar for electrical connection, etc.

In the example illustrated in these figures, support piece 2 is formed by another conductor, designated by general reference 2a in these figures, provided with a reinforcement piece, designated by general reference 2b, at the level of threaded pin 3.

Of course, other embodiments can be envisioned.

Thus it is conceived that by means of such a structure, threaded pin 3 is solidly fastened onto support piece 2.

The connection system according to the invention comprises an annular spacer of electrically conductive material, which is designated by general reference 6 in these figures.

This annular spacer of electrically conductive material 6 is joined to conductor 1, on the side of this conductor that faces support piece 2.

A ring, designated by general reference 7 in these figures, is positioned on the opposite side of this conductor and comprises floating means for coupling onto the spacer, which are designed to extend through corresponding hole 4 of this conductor.

Of course, different embodiments of these floating coupling means can be envisioned.

Thus, for example, these coupling means can have the form of hook-shaped tabs, such as, for example, those designated by references 7a and 7b in these figures, these hook-shaped fastenings being designed to engage in corresponding hole 4 of the conductor and to cooperate with the complementary stop means of spacer 6, formed, for example, by a corresponding rim of this spacer, designated by general reference 6a in these figures.

Thus it is conceived that the engagement of these hook-shaped fastenings in the complementary stop means of the spacer permit assuring a floating coupling of ring 7 onto spacer 6 and therefore onto conductor 1.

Of course, other embodiments can be envisioned, such as, for example, a tubular sleeve of the ring provided with stop means designed to cooperate with rim 6a of the spacer.

Moreover, nut 5 is joined to ring 7 by coupling means allowing the rotation of this nut relative to this ring and a determined course of axial movement of the nut relative to this ring, between a position for assembling distant from this ring, as is illustrated in FIGS. 1 and 2, and a position for screwing in which the nut is supported against this ring, illustrated in FIG. 3.

These means for coupling the nut onto the ring can, of course, have different forms.

Thus, for example, these means for coupling the nut onto the ring can also have the form of hook-shaped tabs, such as, for example, tabs 5a and 5b illustrated in these figures, designed to cooperate with the complementary stop means of ring 7, formed, for example, by a rim 7c of the ring.

Of course, other embodiments can also be envisioned and these means for coupling the nut onto the ring can also have the form of a tubular sleeve of the nut whose free end is provided with stop means designed to cooperate with the complementary stop means of the ring;

In this case, the end of the sleeve of the nut also has at least one projecting part and the complementary stop means of the spacer comprise at least one corresponding rim to assure this coupling of the nut onto the ring.

Thus it is conceived that since the nut is coupled to the ring, it is also joined to the conductor.

This then permits forming a system for assembling with a ring, a nut and a spacer, pieces that cannot be lost, coupled onto the conductor, which can be suitably fastened onto the support piece.

It will also be noted that the conductor hole can have a generally oblong shape, as is illustrated, in particular, in FIGS. 1 and 7, facilitating its centering on the threaded pin.

In fact, the ring, the spacer, and therefore the nut, are mounted in a floating manner on the conductor in the position of assembling, which permits this sub-assembly to move slightly relative to the conductor in the oblong-shaped hole of the conductor, in order to permit compensation for a possible lack of alignment between the threaded pin of the support piece and this sub-assembly.

Moreover, the determined course of axial movement of nut 5 relative to ring 7, between the position of assembling distant from this ring and the position for screwing in which the nut is supported against the ring permits very simply assembling a conductor with several connection systems of this type onto a support piece, as is illustrated in FIG. 7.

In fact, if conductor 1 has several connection systems such as described previously, permitting coupling it onto several studs 3 of a support piece 2, this determined course of axial movement of nut 5 relative to ring 7, permits first positioning conductor 1 against support piece 2, without being hindered by the presence of nuts 5, since they are positioned in their position of assembling distant from the ring, by being pressed back by the studs, and then next, permits screwing the latter nuts one after the other.

In this FIG. 7, the system on the right is shown in the position of assembling, nut 5 being pressed back in the position of assembling by threaded pin 3, while the system on the left is shown in the position for screwing the ring, the conductor and the spacer against support piece 2.

The assembler can then screw the nuts independently of one another, without risk of movement or deformation of the conductor.

Of course, other embodiments can also be envisioned.

1. A system for electrically coupling and fastening at least one electrical conductor in the form of a plate onto a support piece provided with a threaded pin designed to be engaged in a corresponding hole of conductor and to cooperate with a nut for screwing the conductor onto the support piece, characterized in that an annular spacer of electrically conductive material is joined to conductor, on the side of this conductor that faces support piece, and in that a ring is positioned on the opposite side of this conductor and comprises floating means for coupling onto spacer designed to extend through corresponding hole of this conductor and in that nut is joined to ring by coupling means allowing rotation of the nut relative to the ring and a determined course of axial movement of nut relative to this ring, between a position of assembling distant from this ring and a position for screwing in which the nut is supported against this ring, in order to facilitate the positioning and then the screwing of conductor against support piece.

2. The system according to claim 1, further characterized in that hole of the conductor has a generally oblong shape in order to facilitate centering it on the threaded pin.

3. The system according to claim 1, further characterized in that the means for coupling ring onto spacer comprise hook-type tabs designed to engage in corresponding hole of the conductor and to cooperate with complementary stop means of this spacer.

4. The system according to claim 1, further characterized in that the means for fastening nut onto ring comprise hook-type tabs designed to cooperate with complementary stop means of this ring.

5. The system according to claim 1, further characterized in that the means for coupling nut onto ring have the form of a tubular sleeve of the nut provided with stop means designed to cooperate with complementary stop means of ring.

6. The system according to claim 3, further characterized in that the complementary stop means comprise at least one corresponding rim.

7. The system according to claim 1, further characterized in that support piece has a reinforcement piece at the level of threaded pin.

8. The system according to claim 1, further characterized in that support piece is formed by another conductor.

9. The system according to claim 1, further characterized in that support piece is formed by an electrical component.

10. The system according to claim 1, further characterized in that support piece is formed by an electrical connection plate.
